(19) United States
(12) Patent Application Publication
(10) Pub. No.: US 2013/0345354 A1
(43) Pub. Date: Dec. 26, 2013

(54) MOISTURE-CURABLE HOT MELT ADHESIVE

(71) Applicant: HENKEL AG & CO. KGAA, Duesseldorf (DE)

(72) Inventors: Tsuyoshi Tamogami, Osaka (JP); Yoshio Yoshida, Osaka (JP)

(73) Assignee: Henkel AG & Co. KGaA, Duesseldorf (DE)

(21) Appl. No.: 13/795,455

(22) Filed: Mar. 12, 2013

Related U.S. Application Data
(63) Continuation of application No. PCT/JP2012/063578, filed on May 22, 2012.

(30) Foreign Application Priority Data
May 24, 2011 (JP) 2011-116078

(51) Int. Cl. C09J 175/08

(52) U.S. Cl. CPC C09J 175/08
USPC 524/507

(57) ABSTRACT

A moisture-curable hot melt adhesive including a urethane prepolymer having an isocyanate group at the end, and an acrylic polymer (A) having an alicyclic structure, wherein the urethane prepolymer has a chemical structure derived from a crystalline polyesterpolyol. The moisture-curable hot melt adhesive is excellent in initial adhesive strength and excellent in heat resistance. The acrylic polymer (A) may be a chemical structure derived from at least one of (meth)acrylic acid derivatives selected from cyclohexyl (meth)acrylate and isobornyl (meth)acrylate.

### CROSS-REFERENCE TO RELATED APPLICATIONS

This application claims benefit under Paris Convention of Japanese Patent Application No. 2011-116078 filed on May 24, 2011, incorporated herein by reference in its entirety.

### TECHNICAL FIELD

The present invention relates to a moisture-curable hot melt adhesive, and particularly to a moisture-curable hot melt adhesive which is excellent in initial adhesive strength and heat resistance.

### BACKGROUND ART

A moisture-curable hot melt adhesive is employed in various fields such as building interior materials (or building materials) and electronic materials. The moisture-curable hot melt adhesive is an adhesive containing a urethane prepolymer having an isocyanate group at the end, and is generally an adhesive in which, after initial adhesion caused by coating both adherends (or a base material and an adherend) with the adhesive in a hot molten state, and cooling and solidifying, adhesive force, heat resistance and the like are improved by moisture curing caused by cross-linking isocyanate groups with moisture in atmospheric air, and increasing molecular weight of the urethane prepolymer.

One of properties required to the moisture-curable hot melt adhesive includes initial adhesive strength. Means for increasing the initial adhesive strength includes a method in which initial cohesive force is improved by mixing a thermoplastic resin in the moisture-curable hot melt adhesive.

Patent Documents 1 and 2 disclose that cohesive force and adhesive strength of a urethane hot melt adhesive were improved by adding a low-molecular weight acrylic resin (see paragraph 0001 of Patent Document 1, and lines 32 to 35 in a left-hand column on page 2 of Patent Document 2).

However, the moisture-curable hot melt adhesives of both documents did not have initial adhesive strength which was sufficiently satisfactory to users since the acrylic resin mixed as a thermoplastic resin had low molecular weight.

Patent Document 3 discloses a urethane hot melt adhesive to which a high-molecular weight acrylic polymer was added (see claim 1 of Patent Document 3). An improvement in initial adhesive strength of the moisture-curable hot melt adhesive can be expected by the addition of the high-molecular weight acrylic polymer. However, when the molecular weight of the acrylic polymer to be added increases, it becomes difficult for the acrylic polymer to be compatible with a urethane prepolymer.

Furthermore, requirements for the moisture-curable hot melt adhesive become severe in recent years. It is also required for the moisture-curable hot melt adhesive to be excellent in not only the initial adhesive strength, but also heat resistance after moisture curing. Taking high required performance in recent years into consideration, it is hardly to say that the moisture-curable hot melt adhesive of the same document has sufficient heat resistance after moisture curing.

As mentioned above, there has recently desired a moisture-curable hot melt adhesive which is excellent in both initial adhesive strength and heat resistance, and there is an urgent need to develop the moisture-curable hot melt adhesive.
Patent Document 1: JP 06-078515 B
Patent Document 2: JP 06-004840 B
Patent Document 3: JP 2008-500406 A

### DISCLOSURE OF THE INVENTION

### Problem to be Solved by the Invention

The present invention has been made so as to solve such a problem, and an object thereof is to provide a moisture-curable hot melt adhesive which is excellent in initial adhesive strength, and is also excellent in heat resistance.

### Means for Solving the Problems

The present inventors have intensively studied and found, surprisingly, that there can be obtained a moisture-curable hot melt adhesive which is excellent in initial adhesive strength, and is also excellent in heat resistance after moisture curing, by adding a specific acrylic polymer. Thus, the present invention has been completed.

That is, the present invention provides, in an aspect, a moisture-curable hot melt adhesive including a urethane prepolymer having an isocyanate group at the end, and (A) an acrylic polymer having an alicyclic structure (hereinafter also referred to as an “acrylic polymer (A)”), wherein the urethane prepolymer has a chemical structure derived from a crystalline polyesterpolyol.

The present invention provides, in an embodiment, a moisture-curable hot melt adhesive, wherein the acrylic polymer (A) has a chemical structure derived from at least one of (meth)acrylic acid derivatives selected from cyclohexyl (meth)acrylate and isobornyl (meth)acrylate.

The present invention provides, in another embodiment, a moisture-curable hot melt adhesive, wherein the crystalline polyesterpolyol has a melting point of 55° C. or higher.

The present invention provides, in another preferred embodiment, a moisture-curable hot melt adhesive, wherein the acrylic polymer (A) has a glass transition temperature of 60° C. or higher.

As used herein, “alicyclic structure” means a cyclic structure in which carbon atoms are cyclically bonded, and may have either a substituent or a branched structure but does not contain an aromatic ring (for example, benzene ring, naphthalene ring, etc.). Examples of the “alicyclic structure” include cyclohexylene, cyclohexyl, isobornyl and the like.

Such an alicyclic structure is usually derived from an organic compound having an alicyclic structure. In the present invention, specific examples of the “organic compound having an alicyclic structure” include cyclohexane, cyclohexene, cyclohexyl (meth)acrylate, isobornyl (meth)acrylate and the like. From the viewpoint of providing an “alicyclic structure” to the acrylic polymer (A), the organic compound is preferably a monomer which further has an ethylenic (or radical polymerizable) double bond.

In the present description, the “initial adhesive strength” refers to adhesive strength when a moisture-curable hot melt adhesive is melted and applied to an adherend, and then the temperature of the adhesive falls and the adhesive solidifies. The initial adhesive strength is influenced by “wettability” and “cohesive force” of the adhesive. The initial adhesive strength is preferably large.

The “cohesive force” refers to force caused by an interaction working between molecules in the adhesive, which is generated during the process of cooling of the adhesive after applying the hot-melted moisture-curable adhesive using an applicator.

### EFFECTS OF THE INVENTION

The moisture-curable hot melt adhesive according to the present invention includes:

a urethane prepolymer having an isocyanate group at the end, and (A) an acrylic polymer having an alicyclic structure, wherein the urethane prepolymer has a chemical structure derived from a crystalline polyesterpolyol.

Therefore, the moisture-curable hot melt adhesive is excellent in initial adhesive strength, and is also excellent in heat resistance after moisture curing.

Such a moisture-curable hot melt adhesive of the present invention is suited for use in the summer season, and is suited for use in building materials on which severe demands of heat resistance are made.

When the acryliC polymer (A) has a chemical structure derived from at least one of (meth)acrylic acid derivatives selected from cyclohexyl (meth)acrylate and isobornyl (meth)acrylate, the initial adhesive strength and heat resistance after moisture curing are more improved.

When the crystalline polyesterpolyol has a melting point of 55° C. or higher, the initial adhesive strength is remarkably improved.

When the acrylic polymer (A) has a glass transition temperature of 60° C. or higher, the initial adhesive strength is further improved.

### MODE FOR CARRYING OUT THE INVENTION

The moisture-curable hot melt adhesive according to the present invention includes a “urethane prepolymer having an isocyanate group at the end”.

The “urethane prepolymer having an isocyanate group at the end” according to the present invention is usually construed as a “urethane prepolymer”, and “has an isocyanate group at the end” and also has a chemical structure derived from a crystalline polyesterpolyol.

The urethane prepolymer (hereinafter also referred to as a “urethane prepolymer”) according to the present invention can be obtained by reacting a polyol containing a crystalline polyesterpolyol with an isocyanate compound in accordance with a conventionally known method.

In the present invention, the crystalline polyesterpolyol generally refers to those called a crystalline polyesterpolyol, and more particularly refers to a polyesterpolyol having a melting point.

In the present invention, the melting point of the crystalline polyesterpolyol is preferably 55° C. or higher, particularly preferably 60° C. or higher, and most preferably 60° C. to 75° C. When the melting point is 55° C. or higher, the initial adhesive strength of the moisture-curable hot melt adhesive is more improved.

In the present description, the melting point refers to a value measured by differential scanning calorimeter (DSC). By the differential scanning calorimeter, difference in calorie between a measurement sample and a standard reference material is measured and the melting point of the measurement sample is calculated. Specifically, a peak top of an exothermic peak observed when the temperature is raised from −50° C. to 150° C. at a rate of 10° C./minute was regarded as the melting point.

The urethane prepolymer according to the present invention may have a chemical structure derived from the other polyol (for example, amorphous polyesterpolyol, polyetherpolyol, etc.) as long as the prepolymer has a chemical structure derived from the crystalline polyesterpolyol.

The amorphous polyesterpolyol generally refers to those called an amorphous polyesterpolyol, and more particularly refers to a polyesterpolyol which has no melting point and has only a glass transition temperature.

The crystalline polyesterpolyol is easily distinguished from the amorphous polyesterpolyol even by DSC. The melting point of the crystalline polyesterpolyol is observed as an exothermic peak during the temperature rise by the measurement of DSC, and is observed as an endothermic peak during the temperature fall.

Since the melting point of the amorphous polyesterpolyol is not clearly observed when measuring by DSC, it is possible to distinguish from the crystalline polyesterpolyol.

In general, the crystalline polyesterpolyol is white opaque in a solid state, whereas, the amorphous polyesterpolyol is transparent.

The above-mentioned “polyol containing a crystalline polyesterpolyol” can contain a polyol which is used in conventional production of a polyurethane, as long as the objective moisture-curable hot melt adhesive of the present invention can be obtained. These conventionally used polyols may be either crystalline or amorphous.

The polyol is preferably a polyol having 1 to 3 functional groups, and particularly preferably a difunctional polyol, so-called diol. These polyol can be used alone or in combination.

Examples of the diol include low-molecular weight diols having 2 to 12 carbon atoms, such as ethylene glycol, 1-methylethylene glycol, 1-ethylethylene glycol, propylene glycol, butanediol, pentanediol, hexanediol, heptanediol, octanediol, nonanediol, decanediol, dodecanediol, neopentyl glycol, 2-methyl-1,3-propanediol, cyclohexanedimethanol, and 2,4-dimethyl-1,5-pentanediol. At least one selected from ethylene glycol, butanediol, hexanediol and octanediol and decanediol is preferable. These diols can be used alone or in combination.

The “polyol” according to the present invention includes a crystalline polyesterpolyol and may include, for example, the other polyol such as amorphous polyesterpolyol and polyetherpolyol.

Examples of the crystalline polyesterpolyol and amorphous polyesterpolyol include an aliphatic polyesterpolyol and an aromatic polyesterpolyol.

The aliphatic polyesterpolyol can be obtained by reacting an aliphatic dicarboxylic acid with the above-mentioned diol. Examples of the aliphatic dicarboxylic acid include adipic acid, sebacic acid, azelaic acid, and decamethylenedicarboxylic acid. These aliphatic polyesterpolyols may be used alone, or two or more aliphatic polyesterpolyols may be used in combination. Examples of the aliphatic polyesterpolyol include polyhexamethylene adipate (PHMA), polyhexamethylene sebacate (PHMS), polyhexamethylene dodecanate (PHMD), and polybutylene adipate (PBA).

The aromatic polyesterpolyol is preferably obtained by reacting an aromatic poly- (or di-)carboxylic acid with the above-mentioned diol. Examples of the aromatic poly- (or di-) carboxylic acid include phthalic acid, isophthalic acid, terephthalic acid and the like. These aromatic polyesterpolyols may be used alone, or two or more aromatic polyesterpolyols may be used in combination. Examples of the aromatic polyesterpolyol include polyalkylene phthalate, polyalkylene isophthalate, and polyalkylene terephthalate.

Examples of the polyetherpolyol include polyoxytetramethylene glycol (PTMG), polyoxypropylene glycol (PPG), polyoxyethylene glycol (PEG) and the like. The polyetherpolyol is particularly preferably polyoxypropylene glycol.

In the present invention, the polyol containing a crystalline polyesterpolyol preferably contains a polyetherpolyol. Namely, it is preferred that a crystalline polyesterpolyol is mixed with a polyetherpolyol, and the polyol mixture is reacted with an isocyanate compound to synthesize a urethane prepolymer.

In an embodiment of the present invention, it is more preferred that a polyol mixture of a crystalline polyesterpolyol having a melting point of 60° C. to 75° C. with polyoxypropylene glycol is reacted with an isocyanate compound to synthesize a urethane prepolymer.

There is no particular limitation on the isocyanate compound in the present invention, as long as the objective urethane prepolymer can be obtained, and an isocyanate compound which is used in conventional production of a polyurethane may be used. The isocyanate compound preferably has from 1 to 3 isocyanate groups per molecule on average, and is particularly preferably a difunctional isocyanate compound, so-called diisocyanate compound. The isocyanate compound can be used alone, or two or more isocyanate compounds can be used in combination.

Examples of the “isocyanate compound” include ethylene diisocyanate, ethylidene-diisocyanate, propylene diisocyanate, butylene-diisocyanate, hexamethylene-diisocyanate, toluene-diisocyanate, cyclopentylene-1,3-diisocyanate, cyclohexylene-1,4-diisocyanate, cyclohexylene-1,2-diisocyanate, 4,4′-diphenylmethane diisocyanate, 2,2′-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, furfurylidene diisocyanate, 1-chlorobenzene-2,4-diisocyanate and the like. The isocyanate compounds can be used alone or in combination.

In case of producing the “urethane prepolymer” according to the present invention, a monool and a monoisocyanate can be used, and also a trifunctional polyol and a trifunctional isocyanate can be used as long as the objective urethane prepolymer can be obtained. It is preferred to produce using a difunctional polyol(diol) and a difunctional isocyanate (diisocyanate).

It is more preferred that the “urethane prepolymer” is produced by reacting a difunctional polyol with a difunctional isocyanate from the viewpoint of control of thermal stability and a production method (and a production process thereof) of the obtained moisture-curable hot melt adhesive. It is preferred to use 2 mol of the difunctional isocyanate based on 1 mol of the difunctional polyol since the objective urethane prepolymer can be produced comparatively easily.

The moisture-curable hot melt adhesive according to the present invention is produced by mixing the above-mentioned “urethane prepolymer” with an acrylic polymer (A).

Specifically, the moisture-curable hot melt adhesive may be produced by mixing the “urethane prepolymer” produced in advance with the acrylic polymer (A), or the moisture-curable hot melt adhesive may be produced by mixing a polyol and an isocyanate compound, which are precursors of the urethane prepolymer, with the acrylic polymer (A), and then the polyol is reacted with the isocyanate compound.

The acrylic polymer having an alicyclic structure (A) refers to an acrylic polymer which has an alicyclic structure in its carbon skeleton. In general, the acrylic polymer can be obtained by polymerizing monomer(s) containing a monomer which has an alicyclic structure and also has an ethylenic double bond (hereinafter also referred to as a “monomer having an alicyclic structure”). In case of containing an aromatic ring, it is not included in the monomer having an alicyclic structure.

Such a monomer having an alicyclic structure and also having an ethylenic double bond is preferably a (meth)acrylic acid derivative (a) having an alicyclic structure (hereinafter also referred to as a “(meth)acrylic acid derivative(a)”).

Examples of the (meth)acrylic acid derivative (a) include cyclohexyl (meth)acrylate and isobornyl (meth)acrylate, and the (meth)acrylic acid derivative is preferably at least one selected from them, particularly preferably isobornyl methacrylate and cyclohexyl methacrylate, and most preferably cyclohexyl methacrylate. By a chemical structure derived from these alicyclic compounds, the acrylic polymer (A) has an alicyclic structure.

As used herein, the “(meth)acrylic acid derivative” means both methacrylic and acrylic acid derivatives. In case of simply designating as the “methacrylic acid derivative”, methacrylic acid per se is sometimes included. In case of simply designating as the “acrylic acid derivative”, acrylic acid per se is sometimes included.

In the present invention, the acrylic polymer (A) can be obtained by polymerizing only the above-mentioned (meth)acrylic acid derivative (a), which is a monomer having an alicyclic structure. However, the acrylic polymer (A) is preferably a copolymer of the (meth)acrylic acid derivative (a) with the other monomer having an ethylenic double bond (hereinafter also referred to as the “other monomer”).

As used herein, the “other monomer having an ethylenic double bond” refers to a monomer other than the monomer having an alicyclic structure, and examples of the monomer include a monomer which has an aromatic ring and also has an ethylenic double bond (hereinafter also referred to as a “monomer having an aromatic ring”), a monomer which has no cyclic structure but has an ethylenic double bond (hereinafter also referred to as a “monomer having no cyclic structure) and the like.

The other monomer having an ethylenic double bond is preferably a monomer having no cyclic structure, and more preferably a (meth)acrylic acid derivative having no cyclic structure.

In preferred embodiment of the present invention, it is possible to exemplify that an acrylic polymer (A) is formed by copolymerizing a monomer having an alicyclic structure with a (meth)acrylic acid derivative having no cyclic structure, and the acrylic polymer (A) is mixed with a urethane prepolymer.

Examples of the (meth)acrylic acid derivative having no cyclic structure include a (meth)acrylic acid derivative (a′) which may have a chain-like structure in which carbon atoms are bonded in a chain-like form (may be branched). Such a (meth)acrylic acid derivative (a′) can be classified into:

a (meth)acrylic acid derivative (a′) having an alkyl group of 6 or more carbon atoms,

a (meth)acrylic acid derivative (a′) having an alkyl group of less than 6 carbon atoms,

a (meth)acrylic acid (a′), and

the other (meth)acrylic acid derivative (a′).

Examples of the (meth)acrylic acid derivative (a′) having an alkyl group of 6 or more carbon atoms include (meth)acrylic acid esters such as n-hexyl (meth)acrylate, n-octyl (meth)acrylate, 2-ethylhexyl (meth)acrylate, decyl (meth)acrylate, dodecyl (or lauryl) (meth)acrylate, and stearyl (meth)acrylate; and (meth)acrylic acid amides such as N-hexylacrylic acid amide and N-octylacrylic acid amide.

The (meth)acrylic acid ester is preferably a (meth)acrylic acid alkyl ester, and the (meth)acrylic acid amide is preferably a (meth)acrylic acid alkyl amide.

The alkyl group may be either a linear alkyl group (for example, n-hexyl, n-octyl, etc.), or branched alkyl group (for example, 2-ethylhexyl, etc.), or may be an alkyl group which may have a substituent (for example, hydroxyl group, amino group, carboxyl group, glycidyl group, (meth)acryloyl group, methoxy group, etc.) or not. The alkyl group preferably has no substituent.

The (meth)acrylic acid derivative (a′) having an alkyl group of 6 or more carbon atoms preferably includes a (meth)acrylic acid ester having an alkyl group of 6 or more carbon atoms.

These (meth)acrylic acid derivatives may be used alone, or plural (meth)acrylic acid derivatives may be used in combination.

Examples of the (meth)acrylic acid derivative (a′) having an alkyl group of less than 6 carbon atoms include (meth)acrylic acid esters such as methyl (meth)acrylate, ethyl (meth)acrylate, n-propyl (meth)acrylate, isopropyl (meth)acrylate, n-butyl (meth)acrylate, isobutyl (meth)acrylate, and t-butyl (meth)acrylate; (meth)acrylic acid amides such as N,N-dimethylacrylic acid amide, N-butylacrylic acid amide, and N-propylacrylic acid amide; and other derivatives such as 2-(meth)acryloyloxyethylsuccinic acid.

The (meth)acrylic acid ester is preferably a (meth)acrylic acid alkyl ester, and the (meth)acrylic acid amide is preferably a (meth)acrylic acid alkyl amide.

The alkyl group may be an alkyl group having a chain-like structure (for example, methyl, ethyl, propyl, etc.), or may be either a linear alkyl group (for example, n-propyl, n-butyl, etc.) or a branched alkyl group (for example, isobutyl, t-butyl, etc.), or may be an alkyl group which may have a substituent (for example, hydroxyl group, amino group, carboxyl group, glycidyl group, (meth)acryloyl group, methoxy group, etc.) or not. The alkyl group preferably has no substituent.

The (meth)acrylic acid derivative (a′) having an alkyl group of less than 6 carbon atoms preferably includes the (meth)acrylic acid ester having an alkyl group of less than 6 carbon atoms.

These (meth)acrylic acid derivatives may be used alone, or plural (meth)acrylic acid derivatives may be used in combination.

The (meth)acrylic acid (a′) includes at least one selected from acrylic acid and methacrylic acid.

The “other (meth)acrylic acid derivative (a′)” includes acrylonitrile, methacrylonitrile, acrylamide, methacrylamide and the like.

These (meth)acrylic acids and other (meth)acrylic acid derivatives may be used alone, or plural (meth)acrylic acids and other (meth)acrylic acid derivatives may be used in combination.

In the present invention, the acrylic polymer (A) may contain an aromatic ring as long as the objective moisture-curable hot melt adhesive can be obtained, and the aromatic ring is provided by the use of a monomer having an aromatic ring.

Examples of the monomer having an aromatic ring include:

aryl (meth)acrylates such as benzyl (meth)acrylate, phenoxyethyl (meth)acrylate, and 4-hydroxyphenyl (meth)acrylate;

(meth)acrylic acid amides such as 3,5-dimethyl-4-hydroxybenzyl(meth)acrylic acid amide;

esters such as crotonic acid, maleic acid, fumaric acid, and itaconic acid esters; and

styrene, and alkylstyrene.

In an embodiment of the present invention,

the acrylic polymer (A) includes a copolymer of a (meth)acrylic acid derivative (a) which is a monomer having an alicyclic structure with a (meth)acrylic acid derivative (a′) which may have a chain-like structure,

the (meth)acrylic acid derivative (a) is preferably cyclohexyl (meth)acrylate, and particularly preferably cyclohexyl methacrylate, and

the (meth)acrylic acid derivative (a′) is preferably at least one selected from the group consisting of methyl (meth)acrylate, butyl (meth)acrylate, hydroxyethyl (meth)acrylate, and (meth)acrylic acid, and particularly preferably methyl methacrylate, butyl methacrylate, and methacrylic acid.

Therefore, in a most preferable embodiment of the present invention, the acrylic polymer (A) is a copolymer of cyclohexyl methacrylate, methyl methacrylate, butyl methacrylate, and methacrylic acid.

The method of producing an acrylic polymer (A) can be used without any particular limitation as long as the objective moisture-curable hot melt adhesive can be obtained by the method.

Usually, the acrylic polymer can be produced using solution polymerization, bulk polymerization, suspension polymerization and the like.

In the present invention, glass transition temperature (Tg) of an acrylic polymer (A) is preferably 60° C. or higher, and most preferably 80° C. to 100° C. When the Tg is 60° C. or higher, the initial adhesive strength of the finally obtained “moisture-curable hot melt adhesive” is improved.

Since the acrylic polymer (A) is obtained by polymerizing a monomer mixture containing a monomer (a) having an alicyclic structure and the “other monomer (a′) having no alicyclic structure”, the Tg of the acrylic polymer (A) is determined by kinds of the monomer (a) and the “other unsaturated monomer (a′)”, and a mixing ratio (parts by weight) of the monomer (a) to the “other unsaturated monomer (a′)”.

In order to design the acrylic polymer having desired Tg, the mixing ratio (parts by weight) of the monomer (a) to the “other unsaturated monomer (a′)” is determined considering a glass transition temperature of a homopolymer (hereinafter also referred to as “Tg of a homopolymer”) which is obtained when each of the monomer (a) and the other monomer (a′) in the monomer mixture is polymerized alone.

Specifically, “Tg of an acrylic polymer” can be determined by calculating using a calculation formula (I) of a theoretical Tg of an acrylic polymer:

1/Tg=C1/Tg1+C2/Tg2+ . . . +Cn/Tgn: (1)

where Tg in the calculation formula (I) denotes a theoretical Tg of the acrylic polymer, Cn denotes a weight percentage of the nth monomer n contained in a monomer mixture, Tgn denotes Tg of a homopolymer of the nth monomer n, and n denotes the number of monomers constituting the acrylic polymer and is a positive integer.

Values disclosed in a literature can be used as Tg of a homopolymer of a monomer. It is possible to refer, as such a literature, for example, the following literatures: Acryl Ester Catalogue of Mitsubishi Rayon Co., Ltd. (1997 Version); and edited by Kyozo Kitaoka, “Shin Kobunshi Bunko 7, Guide to Synthetic Resin for Coating Material”, Kobunshi Kankokai, published in 1997, pp. 168-169.

An example of design of Tg of the above-mentioned acrylic polymer will be described below.

When cyclohexyl (meth)acrylate (hereinafter also referred to as “CHMA”), which is a monomer whose homopolymer has Tg of 83° C., is used as the monomer (a) and the content in a monomer mixture is adjusted within a range from 40 to 67 parts by weight, for example, a monomer whose homopolymer has Tg of 95° C. or higher and a monomer whose homopolymer has Tg of −50° C. or lower are used as the “other monomer (a′)”. In this case, the content of the former in a monomer mixture is adjusted within a range from 20 to 30 parts by weight, while the content of the latter in a monomer mixture is adjusted within a range from 13 to 30 parts by weight.

Specifically, it is possible to obtain an acrylic polymer (A) showing a theoretical Tg of 10 to 60° C. by using 40 to 67 parts by weight of CHMA whose homopolymer has Tg of 83° C., 20 to 30 parts by weight of methyl methacrylate (hereinafter also referred to as “MMA”, whose homopolymer has Tg of 105° C.) and/or styrene (hereinafter also referred to as “St”, whose homopolymer has a Tg of 100° C.) which is a monomer whose homopolymer has Tg of 95° C. or higher, and 13 to 30 parts by weight of 2-ethylhexyl acrylate (hereinafter also referred to as a “2EHA”, whose homopolymer has Tg of −85° C.) and/or butyl acrylate (hereinafter also referred to as a “BA”, whose homopolymer has Tg of −54° C.) which is a monomer whose homopolymer has Tg of −50° C. or lower, as the “other monomer (a′)”, and then polymerizing a monomer mixture.

Examples of the “monomer (a)” include, in addition to CHMA, methylcyclopentyl methacrylate. Examples of the other monomer (a′) include, in addition to MMA and St, acrylamide (whose homopolymer has Tg of 153° C.), acrylic acid (hereinafter also referred to as “AA”, whose homopolymer has Tg of 106° C.), methacrylic acid (hereinafter also referred to as “MAA”, whose homopolymer has Tg of 130° C.), acrylonitrile (whose homopolymer has Tg of 100° C.), and maleic acid (whose homopolymer has Tg of 130° C.). Examples of the “monomer whose homopolymer has Tg of −50° C. or lower” include, in addition to 2EHA and BA, dodecyl methacrylate (whose homopolymer has Tg of −65° C.)

A value disclosed in Acryl Ester Catalogue of Mitsubishi Rayon Co., Ltd. (1997 Version) is used as the value of Tg of a homopolymer of CHMA, and values disclosed in “Shin Kobunshi Bunko 7, Guide to Synthetic Resin for Coating Material”, Kobunshi Kankokai, published in 1997, pp. 168-169 are used for MMA, St, 2EHA, BA, AA, MAA, acrylamide, acrylonitrile, maleic acid, and dodecyl methacrylate.

In the present invention, weight average molecular weight (Mw) of the acrylic polymer having an alicyclic structure (A) is preferably from 30,000 to 250,000, and particularly preferably from 40,000 to 60,000. When the Mw of the acrylic polymer (A) is within the above range, a moisture-curable hot melt adhesive having excellent initial adhesive strength is obtained.

As used herein, the Mw refers to a value measured by gel permeation chromatography (GPC). More specifically, the Mw refers to a value measured by using the below-mentioned GPC apparatus and measuring method. 600E manufactured by Waters Corporation was used as a GPC apparatus, and RI (Waters410) was used as a detector. Two LF-804 manufactured by Shodex were used as a GPC column. A sample was dissolved in tetrahydrofuran and the obtained solution was allowed to flow at a flow rate of 1.0 ml/min and a column temperature of 40° C., and then the Mw was determined by conversion of the molecular weight using a calibration curve which is obtained by using polystyrene having a monodisperse molecular weight as a standard reference material.

The moisture-curable hot melt adhesive according to the present invention can contain other additives as long as the additives do not exert an adverse influence on a reaction of a polyol with an isocyanate compound to form a urethane prepolymer, and the objective moisture-curable hot melt adhesive of the present invention can be obtained. There is no particular limitation on timing of the addition of additives to a moisture-curable hot melt adhesive, as long as the objective moisture-curable hot melt adhesive of the present invention can be obtained. The additives may be added, for example, together with the polyol and the isocyanate compound in synthesizing the urethane prepolymer. Alternatively, first, the polyol may be reacted with the isocyanate compound to synthesize the urethane prepolymer, and then the additives may be added.

The “additives” are usually used in a moisture-curable hot melt adhesive and there is no particular limitation, as long as the objective moisture-curable hot melt adhesive of the present invention can be obtained. Examples of the additives include a plasticizer, an antioxidant, a pigment, a photostabilizer, a flame retardant, a catalyst, a wax and the like.

Examples of the “plasticizer” include dioctyl phthalate, dibutyl phthalate, dioctyl adipate, mineral spirit and the like.

Examples of the “antioxidant” include a phenol-based antioxidant, a phosphite-based antioxidant, a thioether-based antioxidant, an amine-based antioxidant and the like.

Examples of the “pigment” include titanium oxide, carbon black and the like.

Examples of the “photostabilizer” include benzotriazole, hindered amine, benzoate, benzotriazole and the like.

Examples of the “flame retardant” include a halogen-based flame retardant, a phosphorous-based flame retardant, an antimony-based flame retardant, a metal hydroxide-based flame retardant and the like.

Examples of the “catalyst” include metal catalysts such as tin-based catalysts (trimethylthin laurate, trimethylthin hydroxide, dibutyltin dilaurate, dibutyltin maleate, etc.), lead-based catalysts (lead oleate, lead naphthenate, lead octoate, etc.), and other metal catalysts (naphthenic acid metal salts such as cobalt naphthenate) and amine-based catalysts such as triethylenediamine, tetramethylethylenediamine, tetramethylhexylenediamine, diazabicycloalkenes, dialkylaminoalkylamines and the like.

Examples of the “wax” include waxes such as paraffin wax and microcrystalline wax.

The moisture-curable hot melt adhesive according to the present invention is solid at a normal temperature (15 to 30° C.) and can be used in the fields where a moisture-curable hot melt adhesive has hitherto been used. It can be also used in exterior materials and interior materials for building materials to which higher initial adhesive strength is required, floorings, sticking and profile wrapping of a decorative sheet to a base material and the like.

The above moisture-curable hot melt adhesive is suited for use in case of sticking a decorative material, as a building interior material, to the floor. The use is not limited to sticking to the floor, and it can be also used to stick a decorative sheet to the other base material. Therefore, the moisture-curable hot melt adhesive of the present invention can also be used for woodworking, paper processing, textile processing, general purpose and the like.

In the present invention, the moisture-curable hot melt adhesive can be used in the same manner as in case of a conventional moisture-curable hot melt adhesive, and there is no particular limitation on the usage. For example, in sticking an adherend to a base material, the moisture-curable hot melt adhesive may be applied to a base material side and/or an adherend side.

The “adherend” may be adherends which are usually used, and examples thereof include, but are not limited to, a film, a sheet and the like.

The film may be either colorless or colored, or either transparent or opaque, and examples thereof include films made of a polyolefin resin, a polyester resin, an acetate resin, a polystyrene resin, a vinyl chloride resin and the like. Examples of the polyolefin resin include polyethylene and polypropylene, and examples of the polyester resin include polyethylene terephthalate.

Examples of the decorative sheet include:

sheets made of plastic materials such as a rigid or semi-rigid vinyl chloride resin, a polyolefin resin, and polyester resin;

sliced veneers obtained by forming a timber into a sheet; and

decorative papers subjected to various decorative printings.

In the present invention, it is possible to use “base materials” which are usually used, and examples thereof include, but are not limited to:

plywoods such as lauan plywood, and wood fiber boards such as a medium density fiberboard (MDF), a particle board, a solid wood, and a woody material;

inorganic materials such as a cement board, a gypsum plaster board, and an autoclaved lightweight concrete (ALC); and

plastic materials such as a vinyl chloride resin, a polyolefin resin, and a polyester resin.

A laminated product obtained by bonding an adherend and a base material using the moisture-curable hot melt adhesive according to the present invention can be specifically employed in various fields such as building materials, electronic materials and automobiles. It is not necessary to use a special apparatus so as to produce the laminated product, and the laminated product can be produced by using generally known production apparatuses including a conveyer, a coater, a press, a heater and a cutter. For example, the laminated product can be produced by the following procedure. While allowing a base material and an adherend to flow on a conveyer, the base material or adherend is coated with the moisture-curable hot melt adhesive according to the present invention using a coater. The temperature at the time of coating is controlled to a predetermined temperature by a heater. The adherend and the base material are laminated with each other through the moisture-curable hot melt adhesive by slightly pressing the adherend against the base material using a press. Then, the laminated adherend and base material are left standing to cool and allowed to flow as they are, thereby solidifying the moisture-curable hot melt adhesive. Then, the base material laminated with the adherend is cut into an appropriate size by a cutter.

In these laminated products, since the moisture-curable hot melt adhesive according to the present invention has high initial adhesive strength and is also excellent in heat resistance after moisture curing, peeling becomes less likely to occur between a base material and an adherend even in the summer season.

It is also possible for an operator to apply an adhesive to produce a laminated product without using a coater.

### EXAMPLES

The present invention will be described below by way of Examples and Comparative Examples. However, the present invention is not limited to these Examples as long as the present invention does not depart from the scope of the present invention.

Weight average molecular weights (Mw) of acrylic polymers (A-1) to (A-6) are values measured by gel permeation chromatography (GPC). Molecular weights of acrylic polymers (A′-7) and (A′-8), polyetherpolyol (B), and polyesterpolyol (C) are cited from catalogues of raw materials.

Glass transition temperatures (Tg) of acrylic polymers (A-1) to (A-6) are values calculated from the compositions of raw monomers. Glass transition temperatures (Tg) of acrylic polymers (A′-7) and (A′-8) are cited from a catalogue of raw materials.

Melting points (M. P) of components (A) to (C) are values measured by differential scanning calorimeter (DSC).

### Acrylic Polymer

(A) Acrylic polymer having an alicyclic structure

(A-1) Acrylic polymer having a cyclohexyl structure, a weight average molecular weight (Mw) of 50,000, and a glass transition temperature (Tg) of 61° C.

(A-2) Acrylic polymer having a cyclohexyl structure, a weight average molecular weight (Mw) of 50,000, and a glass transition temperature (Tg) of 70° C.

(A-3) Acrylic polymer having a cyclohexyl structure, a weight average molecular weight (Mw) of 50,000, and a glass transition temperature (Tg) 83° C.

(A-4) Acrylic polymer having a cyclohexyl structure, a weight average molecular weight (Mw) of 50,000, and a glass transition temperature (Tg) of 93° C.

(A-5) Acrylic polymer having a cyclohexyl structure, a weight average molecular weight (Mw) of 50,000, a glass transition temperature (Tg) of 93° C.

(A-6) Acrylic polymer having an isobornyl structure, a weight average molecular weight (Mw) of 50,000, and a glass transition temperature (Tg) of 140° C.

(A′) Acrylic polymer having no alicyclic structure

(A′-7) Acrylic polymer obtained from only a (meth)acrylic acid derivative (a′) having no alicyclic structure (manufactured by Mitsubishi Rayon Co., Ltd., BR113 (product name) having Mw of 35,000 and a glass transition temperature (Tg) of 75° C.)

(A′-8) Acrylic polymer obtained from only a (meth)acrylic acid derivative (a′) having no alicyclic structure (manufactured by Mitsubishi Rayon Co., Ltd., BR106 (product name) having Mw of 60,000 and a glass transition temperature (Tg) of 50° C.

Synthesis of the above-mentioned acrylic polymers (A-1) to (A-6) are mentioned below.

### (B) Polyetherpolyol

(B-1) Polyoxypropylene glycol (manufactured by Dai-ichi Kogyo Seiyaku Co., Ltd., HIFLEX D2000 (product name) having a hydroxyl value of 56 (mgKOH/g) and a weight average molecular weight (Mw) of 2,000)

(B-2) Polyoxypropylene glycol (manufactured by Dai-ichi Kogyo Seiyaku Co., Ltd., HIFLEX D400 (product name) having a hydroxyl value of 280 (mgKOH/g) and a weight average molecular weight (Mw) of 400)

(C) Polyesterpolyol

(C-1) Crystalline polyhexamethylene adipate (manufactured by HOKOKU CORPORATION HS 2H-351A (product name) having a melting point of 55° C., a hydroxyl value of 32 (mgKOH/g), and a weight average molecular weight (Mw) of 3,500)

(C-2) Crystalline polyhexamethylene sebacate (manufactured by HOKOKU CORPORATION HS 2H-350S (product name) having a melting point of 65° C., a hydroxyl value of 32 (mgKOH/g), and a weight average molecular weight (Mw) of 3,500)

(C-3) crystalline hexamethylene dodecanate (manufactured by UBE INDUSTRIES, LTD. ETERNACOLL 3010 (product name) having a melting point of 70° C., a hydroxyl value of 32 (mgKOH/g), and a weight average molecular weight (Mw) of 3,500)

(C′-4) Amorphous polyesterpolyol (manufactured by Asahikawa Kagaku Co., Ltd.), PES0001 (product name) having no melting point (liquid at 20° C.), a hydroxyl value of 56 (mgKOH/g), and a weight average molecular weight (Mw) of 2,000)

### Isocyanate Compound

4,4′-diphenylmethanediisocyanate (hereinafter also referred to as “MDI”) (manufactured by Nippon Polyurethane Industry Co., Ltd., MILLIONATE MT (product name))

### Other Additives

### Initiator

Azobisisobutyronitrile (AIBN, manufactured by Otsuka Chemical Co., Ltd.)

### Synthesis of Acrylic Polymer (A)

A (meth)acrylic acid derivative (a) having an alicyclic structure was mixed with a (meth)acrylic acid derivative (a′) which has no cyclic structure and may have a chain-like structure, and then the mixture was polymerized to produce the acrylic polymers (A-1) to (A-6).

The (meth)acrylic acid derivative (a) and the (meth)acrylic acid derivatives (a′), which serve as raw materials of the acrylic polymer (A), are shown below.

(a-1) Cyclohexyl methacrylate

(a-2) Isobornyl methacrylate (manufactured by Kyoeisha Chemical Co., Ltd., IB-X (product name))

(a′-3) Methyl methacrylate

(a′-4) Butyl methacrylate

(a′-5) Methacrylic acid

(a′-6) 2-hydroxyethyl methacrylate

The production of the acrylic polymer (A-1) will be described in detail below.

### Production of (A-1)

| | | |
|---|---|---|
| (a-1) | Cyclohexyl methacrylate | 150 g |
| (a′-3) | Methyl methacrylate | 45 g |
| (a′-4) | Butyl methacrylate | 105 g |
| (a′-5) | Methacrylic acid | 1.5 g |

The monomer (a) was mixed with the monomers (a′) in the above weights to prepare 301.5 g in total of a monomer mixed solution. In a 2 L reaction vessel, 549 g of the polyetherpolyol (B-1) was charged and 50 g of the above-mentioned monomer mixed solution was added to the same reaction vessel, and also 4.0 g of azobisisobutyronitrile (AIBN) as a polymerization initiator was added to the same reaction vessel.

After attaching a stirring blade, a reflux condenser tube and a thermometer to the reaction vessel, the same reaction vessel was immersed in a warm bath at 80° C. and a polymerization reaction was initiated while stirring the mixed solution in the vessel. After about twenty minutes from generation of reaction heat, the remainder of the above-mentioned monomer mixed solution was added dropwise over about 2 hours.

After thirty minutes from completion of the dropwise addition, 0.15 g of AIBN was added every 30 minutes for three times, followed by stirring at 90° C. for 2 hours. After completion of the stirring, the prepared acrylic polymer solution was removed from the reactor. The concentration of the acrylic polymer prepared solution was 32.8% by weight.

### Production of Acrylic Polymers (A-2) to (A-6)

After mixing a monomer (a) with monomers (a′) according to the composition shown in Table 1 to obtain a monomer mixture, the acrylic polymers (A-2) to (A-6) were produced in the same manner as in (A-1). The commercially available products (A′-7) to (A′-8) were used as they are. The compositions (A-1) to (A′-8) are as shown in Table 1.

TABLE 1

| | | | | | | | (A′-7) | (A′-8) |
|---|---|---|---|---|---|---|---|---|
| | | | | | | | Commercially | Commercially |
| | | | | | | | available | available |
| | (A-1) | (A-2) | (A-3) | (A-4) | (A-5) | (A-6) | product | product |
| Monomer | 150 | 150 | 150 | 150 | 150 | | | |
| (a) | | | | | | | | |
| (a-1) | | | | | | | | |
| (a-2) | | | | | | 150 | | |
| (a′-3) | 45 | 75 | 120 | 150 | 150 | 150 | 210 | 120 |
| (a′-4) | 105 | 75 | 30 | | | | 90 | 180 |
| (a′-5) | 1.5 | 1.5 | 1.5 | 1.5 | 1.5 | 1.5 | 1.5 | 1.5 |
| (a′-6) | | | | | 0.9 | | | |
| AIBN | 4.5 | 4.5 | 4.5 | 4.5 | 4.5 | 4.5 | | |
| Treatment | 0.15 × 3 | 0.15 × 3 | 0.15 × 3 | 0.15 × 3 | 0.15 × 3 | 0.15 × 3 | | |
| of residual | | | | | | | | |
| monomer, | | | | | | | | |
| AIBN | | | | | | | | |

### Production of Moisture-Curable Hot Melt Adhesive

### Examples 1 to 6 and Comparative Examples 1 to 5

A polyol, an isocyanate compound, and an acrylic polymer (A) were mixed according to the compositions shown in Table 2 to produce moisture-curable hot melt adhesives.

Specifically, a polyol and an acrylic polymer (A) were charged in a reaction vessel and stirred under reduced pressure for 1 hour. After removing moisture, an isocyanate compound (4,4′-diphenylmethanediisocyanate) was added at the same temperature under reduced pressure, followed by stirring for 2 hours to obtain a moisture-curable hot melt adhesive.

The numerical value of the acrylic polymer (A) disclosed in Table 2 is a numerical value (value in terms of the solid content) after removal of the solvent.

TABLE 2

| Kinds of | Names of | | | | | |
|---|---|---|---|---|---|---|
| raw materials | raw materials | | Example 1 | Example 2 | Example 3 | Example 4 |
| Acrylic polymer | (A-1) | | 20.7 | | | |
| (A) | (A-2) | | | 20.7 | | |
| | (A-3) | | | | 20.7 | |
| | (A-4) | | | | | 20.7 |
| | (A-5) | | | | | |
| | (A-6) | | | | | |
| Acrylic polymer | (A′-7) | | | | | |
| (A′) | (A′-8) | | | | | |
| Polyetherpolyol | (B-1) | | 38.3 | 38.3 | 38.3 | 38.3 |
| (B) | (B-2) | | 4.4 | 4.4 | 4.4 | 4.4 |
| Crystalline | (C-1) | | | | | |
| polyesterpolyol | (C-2) | | 22.1 | 22.1 | 22.1 | 22.1 |
| (C) | (C-3) | | | | | |
| Amorphous | (C′-4) | | | | | |
| polyesterpolyol | | | | | | |
| (C′) | | | | | | |
| Isocyanate | MDI | | 14.5 | 14.5 | 14.5 | 14.5 |
| Total | | | 100.0 | 100.0 | 100.0 | 100.0 |
| | Viscosity | | 7,000 | 8,000 | 11,000 | 12,000 |
| Initial strength | Initial peel strength | | 3.0 | 3.5 | 3.0 | 3.5 |
| before curing | (kg/25 mm 33° C.) | | MF | MF | MF | MF |
| | | | B | B | B | B |
| | Initial peel strength | | 3.5 | 3.5 | 4.0 | 4.0 |
| | (kg/25 mm 30° C.) | | MF | MF | MF | MF |
| | | | B | B | A | A |
| | Initial peel strength | | 3.5 | 3.5 | 4.0 | 4.0 |
| | (kg/25 mm 28° C.) | | MF | MF | MF | MF |
| | | | B | B | A | A |
| Physical properties | Heat-resistant | 80° C. | B | B | B | B |
| after curing | creep (mm) | 90° C. | B | B | B | B |
| | | 100° C. | B | B | B | B |
| Kinds of | Names of | | | | | |
| raw materials | raw materials | | Example 5 | Example 6 | Example 7 | Example 8 |
| Acrylic polymer | (A-1) | | | | | |
| (A) | (A-2) | | | | | |
| | (A-3) | | | | | |
| | (A-4) | | | | | |
| | (A-5) | | 20.7 | 20.7 | 20.7 | |
| | (A-6) | | | | | 20.7 |
| Acrylic polymer | (A′-7) | | | | | |
| (A′) | (A′-8) | | | | | |
| Polyetherpolyol | (B-1) | | 38.3 | 38.3 | 38.3 | 38.3 |
| (B) | (B-2) | | 4.4 | 4.4 | 4.4 | 4.4 |
| Crystalline | (C-1) | | 22.1 | | | |
| polyesterpolyol | (C-2) | | | 22.1 | | 22.1 |
| (C) | (C-3) | | | | 22.1 | |
| Amorphous | (C′-4) | | | | | |
| polyesterpolyol | | | | | | |
| (C′) | | | | | | |
| Isocyanate | MDI | | 14.5 | 14.5 | 14.5 | 14.5 |
| Total | | | 100.0 | 100.0 | 100.0 | 100.0 |
| | Viscosity | | 11,000 | 12,000 | 12,000 | 7,000 |
| Initial strength | Initial peel strength | | 2.3 | 3.5 | 4.0 | 3.2 |
| before curing | (kg/25 mm 33° C.) | | CF | MF | MF | MF |
| | | | C | B | A | B |
| | Initial peel strength | | 2.5 | 4.0 | 4.0 | 3.2 |
| | (kg/25 mm 30° C.) | | CF | MF | MF | MF |
| | | | C | A | A | B |
| | Initial peel strength | | 3.5 | 4.0 | 4.0 | 4.0 |
| | (kg/25 mm 28° C.) | | MF | MF | MF | MF |
| | | | B | A | A | A |
| Physical properties | Heat-resistant | 80° C. | B | B | B | B |
| after curing | creep (mm) | 90° C. | B | B | B | B |
| | | 100° C. | B | B | B | B |
| Kinds of | Names of | | Comparative Example | | | |
| raw materials | raw materials | | 1 | 2 | 3 | 4 |
| Acrylic polymer | (A-1) | | | | | |
| (A) | (A-2) | | | | | |
| | (A-3) | | | | | |
| | (A-4) | | | | | |
| | (A-5) | | | | | 20.7 |
| | (A-6) | | | | | |
| Acrylic polymer | (A′-7) | | 27.5 | 20.7 | | |
| (A′) | (A′-8) | | | | 20.7 | |
| Polyetherpolyol | (B-1) | | 42.0 | 38.0 | 38.0 | 38.2 |
| (B) | (B-2) | | | 4.5 | 4.5 | 4.4 |
| Crystalline | (C-1) | | 18.0 | | | |
| polyesterpolyol | (C-2) | | | 22.1 | 22.1 | |
| (C) | (C-3) | | | | | |
| Amorphous | (C′-4) | | | | | 22.1 |
| polyesterpolyol | | | | | | |
| (C′) | | | | | | |
| Isocyanate | MDI | | 12.5 | 14.7 | 14.7 | 14.5 |
| Total | | | 100.0 | 100.0 | 100.0 | 100.0 |
| | Viscosity | | 7,000 | Immiscible | 8000 | 10,000 |
| Initial strength | Initial peel strength | | 1.2 | | 1.5 | 1.2 |
| before curing | (kg/25 mm 33° C.) | | CF | | CF | CF |
| | | | D | | D | D |
| | Initial peel strength | | 1.2 | | 1.5 | 1.4 |
| | (kg/25 mm 30° C.) | | CF | | CF | CF |
| | | | D | | D | D |
| | Initial peel strength | | 1.5 | | 1.5 | 1.6 |
| | (kg/25 mm 28° C.) | | CF | | CF | CF |
| | | | D | | D | D |
| Physical properties | Heat-resistant | 80° C. | D | | C | B |
| after curing | creep (mm) | 90° C. | D | | C | B |
| | | 100° C. | D | | D | B |

In order to evaluate initial adhesive strength of the moisture-curable hot melt adhesives of Examples and Comparative Examples, initial peel strength was measured at each temperature. In order to evaluate heat-resistant adhesiveness, a heat-resistant creep test was carried out. Furthermore, in order to evaluate coating performance, viscosity was measured. Test procedures and evaluation criteria are shown below.

### Evaluation of Initial Strength Before Curing (Measurement of Initial Peel Strength)

As materials to be tested, a medium-density fiberboard (MDF) kept warmed in an incubator at 40° C. for 12 hours or more and an olefin sheet subjected to an easy adhesion treatment using a primer were used.

The moisture-curable hot melt adhesives of Examples and Comparative Examples were melted at 120° C., and the olefin sheet side was coated by a T-die coater in a coating amount of 40 g/m² and immediately laminated to MDF, followed by roll pressing. After roll pressing, 180° peel strength was measured by a hand peel tester while measuring a surface temperature during natural cooling after roll pressing.

The initial peel strength was evaluated by the following criteria.

D: Case where initial peel strength is less than 2.0 kg/25

C: Case where initial peel strength is 2.0 kg/25 mm or more and less than 3.0 kg/25 mm

B: Case where initial peel strength is 3.0 kg/25 mm or more and less than 4.0 kg/25 mm

A: Case where initial peel strength is 4.0 kg/25 mm or more

Further, the cases where MDF or an olefin sheet was fractured on peeling were indicated by the symbol “MF”, while the case where an adhesive layer was fractured were indicated by the symbol “CF”. The MF is more preferable since it is apparent that the strength of the adhesive layer per se is stronger than those of the MDF and the olefin sheet.

Evaluation of Heat Resistance (Measurement of Heat-Resistant Creep after Curing)

As materials to be tested, a particleboard stored at 20° C. for 12 hours or more and a non-treated PET sheet were used.

The moisture-curable hot melt adhesives of Examples and Comparative Example were melted at 120° C., and the particleboard side was coated by a roll coater at 120° C. in a coating amount of 40 g/m². The PET sheet was bonded to the particleboard at open time of 30 seconds, and laminated by a roll press. After the lamination, the obtained laminate was aged under an environment at 20° C. and 50% RH for 3 days.

After the aging, a slit was made in a width of 25 mm from above the sheet and an end of the PET sheet was peeled by about 20 mm, and then a weight of 500 g was hung on the peeled end. After maintained at each temperature (80, 90, 100° C.) for 4 hours, a creeping distance was measured.

Heat-resistant creep was evaluated by the following criteria.

D: Creeping distance of 10 mm or more

C: Creeping distance of 2 mm or more and less than 10 mm

B: Creeping distance of less than 2 mm

### Measurement of Viscosity

Using a viscometer (manufactured by Brookfield Engineering Labs), viscosity was measured.

A molten moisture-curable hot melt adhesive (10.5 g) was charged in a viscosity tube and a spindle (lot number 27) was inserted into the viscometer, followed by being left to stand at 120° C. for 30 minutes. After rotating the spindle at a speed of 5 rpm for 1 minute, melt viscosity was measured at 120° C.

As shown in Table 2, the moisture-curable hot melt adhesives of Examples 1 to 6 are excellent in both initial peel strength and heat-resistant creep since the acrylic polymer (A) contains an alicyclic structure and the urethane prepolymer contains a chemical structure derived from a crystalline polyesterpolyol (C).

The moisture-curable hot melt adhesives of Examples are suited for use in the summer season since they are excellent in initial peel strength at 28° C. to 33° C., and are suited for use in building materials on which severe demands of heat resistance are made since they are also excellent in heat-resistant creep.

In contrast, the moisture-curable hot melt adhesives of Comparative Examples 1 to 4 are inferior in either performance such as initial peel strength or heat-resistant creep.

The moisture-curable hot melt adhesives of Comparative Examples 1 to 3 are inferior in both initial peel strength and heat-resistant creep since the acrylic polymer (A′) has no alicyclic structure.

The moisture-curable hot melt adhesive of Comparative Example 4 has low initial peel strength since the urethane prepolymer does not contain a chemical structure derived from a crystalline polyesterpolyol (C).

### INDUSTRIAL APPLICABILITY

The present invention provides a moisture-curable hot melt adhesive. The moisture-curable hot melt adhesive according to the present invention can be used in exterior materials and interior materials for building materials, floorings, sticking and profile wrapping of a decorative sheet to a base material and the like.

What is claimed is:

1. A moisture-curable hot melt adhesive comprising:
a urethane prepolymer having an isocyanate group at the end, and
an acrylic polymer (A) having an alicyclic structure, wherein the urethane prepolymer has a chemical structure derived from a crystalline polyesterpolyol.

2. The moisture-curable hot melt adhesive according to claim 1, wherein the acrylic polymer (A) has a chemical structure derived from at least one of (meth)acrylic acid derivatives selected from cyclohexyl (meth)acrylate and isobornyl (meth)acrylate.

3. The moisture-curable hot melt adhesive according to claim 1, wherein the crystalline polyesterpolyol has a melting point of 55° C. or higher.

4. The moisture-curable hot melt adhesive according to claim 1, wherein the acrylic polymer (A) has a glass transition temperature of 60° C. or higher.
